(19) United States
(12) Patent Application Publication
(10) Pub. No.: US 2013/0081469 A1
(43) Pub. Date: Apr. 4, 2013

(54) MULTI-SENSING APPARATUS AND METHOD THEREOF

(71) Applicant: Boum Seock Kim, Gyunggi-do (KR)

(72) Inventor: Boum Seock Kim, Gyunggi-do (KR)

(73) Assignee: SAMSUNG ELECTRO-MECHANICS CO., LTD., Gyunggi-do (KR)

(21) Appl. No.: 13/328,249

(22) Filed: Dec. 16, 2011

(30) Foreign Application Priority Data
Sep. 29, 2011 (KR) 1020110099010

(51) Int. Cl. G01N 29/04

(52) U.S. Cl. 73/628

(57) ABSTRACT

Disclosed herein are a multi-sensing apparatus and a method thereof. The multi-sensing apparatus includes a plurality of ultrasonic sensors including a wave transmission unit transmitting an ultrasonic wave signal of a corresponding transmission frequency, and a wave reception unit receiving and outputting the ultrasonic wave signal transmitted from the wave transmission unit, and an analyzed integrated circuit controlling each of the wave transmission units of the plurality of ultrasonic sensors to transmit the ultrasonic wave signal of the corresponding transmission frequency, receiving an ultrasonic reflected signal received from each of the reception wave units, and computing and outputting a distance of an object sensed by a corresponding ultrasonic sensor using a time difference between a transmission time and a reception time.

### CROSS REFERENCE TO RELATED APPLICATION

This application claims the benefit of Korean Patent Application No. 10-2011-0099010, filed on Sep. 29, 2010, entitled “Multi Sensing Apparatus And Method Thereof”, which is hereby incorporated by reference in its entirety into this application.

### BACKGROUND OF THE INVENTION

1. Technical Field

The present invention relates to a multi-sensing apparatus and a method thereof.

2. Description of the Related Art

Generally, an ultrasonic sensor which includes a wave transmission unit for transmitting ultrasonic waves and a wave reception unit for receiving the transmitted ultrasonic waves may be installed in an installation body in which the ultrasonic sensor is installed, and sense a distance between the installation body and an object using the time spent until the ultrasonic waves transmitted in the wave transmission unit is reflected on the object and received by the wave reception unit after the ultrasonic waves are transmitted in the wave transmission unit.

The ultrasonic sensor may be installed in an upper portion of a liquid reservoir in which a liquid is stored, and detect a water level of the liquid to thereby be used to detect a flow rate of a liquid. Alternatively, the ultrasonic sensor may be installed at a rear portion of a vehicle which cannot be visually seen by a driver to thereby be used to sense obstacles positioned at the rear of the vehicle.

In the prior art, a plurality of ultrasonic sensors have been installed in the installation body to be used, as disclosed in Japanese Patent Publication No. Hei 9-156501.

In this manner, when the plurality of ultrasonic sensors are installed, each of the plurality of ultrasonic sensors may invert an electrical pulse signal into an ultrasonic wave signal to radiate the ultrasonic wave signal in a detection area, and the ultrasonic reflected signal which hits on an object to be reflected may be received for each of the plurality of the ultrasonic sensors to thereby be analyzed by an analyzed integrated circuit for analyzing the received signal.

As described above, when being installed and used in the installation body of the prior art, the plurality of ultrasonic sensors have the same sensor characteristics in that each of the plurality of ultrasonic sensors use the same fixed ultrasonic transmission frequency, and use a gain of the same fixed ultrasonic reception circuit and the fixed number of transmission pulses, so that an analyzed integrated circuit corresponding to each of the plurality of ultrasonic sensors may be needed.

In this manner, when sensing an object using the plurality of ultrasonic sensors, the analyzed integrated circuit for each of the plurality of ultrasonic sensors may be needed, so that costs increase, and miniaturization of the product is difficult due to an increase in an installation area.

### SUMMARY OF THE INVENTION

The present invention has been made in an effort to provide a multi-sensing apparatus and a method thereof, in which a plurality of ultrasonic sensors use mutually different transmission frequencies to use a single analyzed integrated circuit.

According to a preferred embodiment of the present invention, there is provided a multi-sensing apparatus, including: a plurality of ultrasonic sensors including a wave transmission unit transmitting an ultrasonic wave signal of a corresponding transmission frequency, and a wave reception unit receiving and outputting the ultrasonic wave signal transmitted from the wave transmission unit; and an analyzed integrated circuit controlling each of the wave transmission units of the plurality of ultrasonic sensors to transmit the ultrasonic wave signal of the corresponding transmission frequency, receiving an ultrasonic reflected signal received from each of the reception wave units, and computing and outputting a distance of an object sensed by a corresponding ultrasonic sensor using a time difference between a transmission time and a reception time.

Also, each of the wave transmission units of the plurality of ultrasonic sensors may include a cylindrical case having a bottom, a piezoelectric element formed in an inner bottom surface of the to case, a terminal electrically connected to the piezoelectric element, and a substrate in which the terminal is fixed, and each of the wave transmission units of the plurality of ultrasonic sensors has mutually different transmission frequencies by adjusting a thickness or a diameter of the bottom surface of the case of the corresponding wave transmission unit, or a material constant of the piezoelectric element to be different from each other.

Also, each of the wave reception units of the plurality of ultrasonic sensors may include an ultrasonic receiver receiving an ultrasonic wave which hits on a predetermined object to be reflected, a band-pass filter enabling only a resonance frequency having a maximum voltage among frequencies received from the ultrasonic receiver to pass therethrough, and an amplifier adjusting an amplification ratio of the ultrasonic wave signal passing through the band-pass filter in accordance with a scale of a predetermined noise.

Also, each of the wave reception units of the plurality of ultrasonic sensors may further include a detector detecting a signal passing through the amplification, and a comparator comparing the signal detected in the detector with a linear reference signal to convert the compared value into a digital value.

Also, the analyzed integrated circuit may include an oscillator generating a clock signal, a plurality of single-pulse generators generating a single driving pulse of a corresponding resonance frequency by receiving the clock signal, a pulse selector selecting and outputting any one of the single driving pulses output from the plurality of single-pulse generators, and a driving signal output unit applying the single driving pulse output from the pulse selector to the corresponding ultrasonic sensor.

Also, the analyzed integrated circuit may include a sensor recognizer receiving the ultrasonic wave signal input from the wave reception unit to recognize the corresponding ultrasonic sensor, a signal processor computing a distance of an object sensed using the transmission time and the reception time of the ultrasonic wave signal of the ultrasonic sensor recognized in the sensor recognizer, and a controller controlling a pulse selector and a driving signal output unit.

According to another preferred embodiment of the present invention, there is provided a multi-sensing method, including: sequentially outputting an ultrasonic wave signal of a corresponding transmission frequency by driving a plurality of ultrasonic sensors by an analyzed integrated circuit; receiving and outputting, by the plurality of ultrasonic sensors, an ultrasonic reflected signal in which the transmitted ultrasonic wave signal is reflected and returned; and receiving, by the analyzed integrated circuit, the ultrasonic wave signal received from the plurality of ultrasonic sensors, and identifying the ultrasonic sensor in which the ultrasonic wave signal is input, and computing and outputting a distance using a transmission time and a reception time of the ultrasonic wave signal of the corresponding ultrasonic sensor.

Also, the sequentially outputting may include generating a clock signal by driving an oscillator by a controller of the analyzed integrated circuit, generating and outputting a pulse signal having a corresponding resonance frequency by receiving the clock signal by a plurality of single-pulse generators of the analyzed integrated circuit, sequentially selecting and outputting, by a pulse selector of the analyzed integrated circuit, a pulse signal output from the plurality of single-pulse generators in accordance with a control of the controller, outputting, by a driving signal output unit of the analyzed integrated circuit, the pulse signal of the corresponding resonance frequency to the corresponding ultrasonic sensor in accordance with the control of the controller, and generating and transmitting the corresponding ultrasonic wave signal by a wave transmission unit of the corresponding ultrasonic sensor.

Also, the receiving of the ultrasonic wave signal may include recognizing, by a sensor recognizer of the analyzed integrated circuit, the ultrasonic sensor in which the ultrasonic wave signal is input when the ultrasonic wave signal is input from the plurality of ultrasonic sensors, and determining the corresponding ultrasonic sensor, and computing and outputting, by a signal processor of the analyzed integrated circuit, the distance of an object sensed by the corresponding ultrasonic sensor using the transmission time and the reception time of the ultrasonic wave signal of the ultrasonic sensor recognized in the sensor recognizer.

### BRIEF DESCRIPTION OF THE DRAWINGS

FIG. 1 is a configuration diagram illustrating a multi-sensing apparatus according to an embodiment of the present invention;

FIG. 2 is a cross-sectional diagram illustrating a wave transmission unit of FIG. 1;

FIG. 3 is an inner block diagram illustrating a wave reception unit of FIG. 1;

FIG. 4 is an inner block diagram illustrating an analyzed integrated circuit of FIG. 1;

FIG. 5 is a flowchart illustrating a multi-sensing method according to an embodiment of the present invention;

FIG. 6 is a detailed configuration diagram illustrating outputting of an ultrasonic wave signal of FIG. 5; and

FIG. 7 is a flowchart illustrating computing of a distance of FIG. 5.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description will be omitted.

Hereinafter, the preferred embodiments of the present invention will be described in detail with reference to the accompanying drawings.

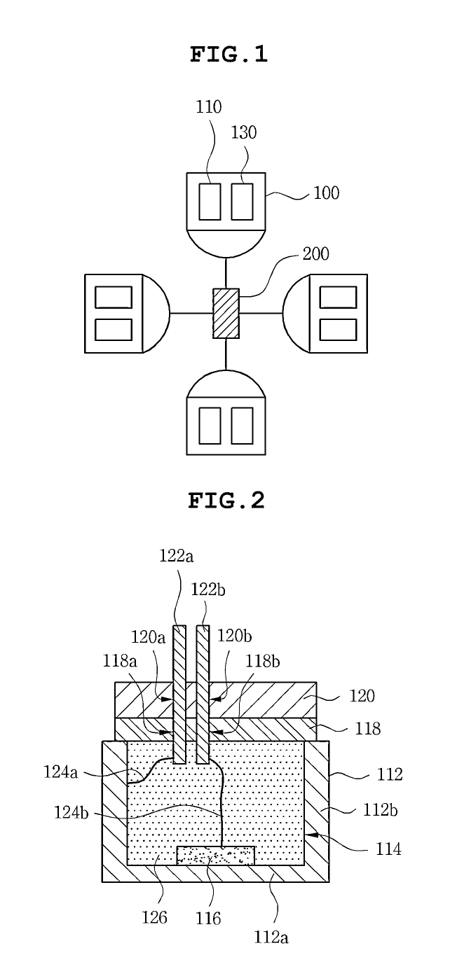

FIG. 1 is a configuration diagram illustrating a multi-sensing apparatus according to an embodiment of the present invention.

Referring to FIG. 1, a multi-sensing apparatus according to the preferred embodiment of the present invention may include a plurality of ultrasonic sensors 100 having a wave transmission unit 110 and a wave reception unit 130, and an analyzed integrated circuit 200.

First, the plurality of ultrasonic sensors 100 may be fixed and installed in an installation body, and the wave transmission unit 110 of each of the plurality of ultrasonic sensors 100 may transmit an ultrasonic wave signal of a transmission frequency corresponding to a corresponding resonance frequency.

In this instance, by adjusting the output, antenna characteristics, and the like of the ultrasonic wave signal transmitted from each of the wave transmission units 110, a position, a distance, or the like in which the corresponding ultrasonic wave signal reaches a sensed area may be designed to be a desired level.

Referring to FIG. 2 illustrating a change in the impedance in a range of a resonance frequency in the wave transmission unit 110, it may be found that the amplitude is quickly lowered even when deviated only by 1 KHz from the resonance frequency.

Accordingly, when applying a frequency of 46 KHz to the wave transmission unit 110 having the resonance frequency of, for example, 48 KHz, an SPL (Sound Pressure Level) is lowered by 3 dB or more compared to 48 KHz. Here, 3 dB in the SPL characteristic value may be analyzed as indicating the characteristic value difference of cutting compared to the peak so that 3 dB is generally processed as meaningless data in the analyzed integrated circuit 200.

By slightly changing a thickness or a diameter of a bottom surface of a case, a material constant of a piezoelectric element, or the like, the resonance frequency may be easily changed in the wave transmission unit 110 having the above characteristics.

Preferably, the wave transmission units 110 of the plurality of ultrasonic sensors 100 may be sequentially driven to transmit an ultrasonic wave signal of a corresponding transmission frequency. Obviously, the wave transmission units 110 of the plurality of ultrasonic sensors 100 may be simultaneously driven to transmit the ultrasonic wave signal of the corresponding transmission frequency.

Next, each of the wave reception units 130 of the plurality of ultrasonic sensors 100 may receive the ultrasonic wave signal transmitted from the wave transmission unit 110 of the corresponding ultrasonic sensor 100, and output the received signal to the analyzed integrated circuit 200.

In this manner, when being designed to receive the ultrasonic wave signal of the transmission frequency transmitted from the wave transmission unit 110 of the corresponding ultrasonic sensor 100, each of the wave reception units 130 of the plurality of ultrasonic sensors 100 may identify the wave transmission unit 110 transmitting a corresponding signal based on individual characteristics of these signals even when receiving the ultrasonic wave signal transmitted from the plurality of wave transmission units 110.

Meanwhile, the analyzed integrated circuit 200 may control each of the wave transmission units 110 of the plurality of ultrasonic sensors 100 to transmit the ultrasonic wave signal of the corresponding transmission frequency, receive an ultrasonic reflected signal received from each of the wave reception units 130, and compute and output a distance of a corresponding object using a time difference.

In this instance, since a signal is input 48,000 times per second when the used resonance frequency is a frequency around 48 KHz, a time required for sequentially inputting the frequency may be actually about 4/48,000 seconds. However, since a time required until the analyzed integrated circuit 200 removes noise of each of the ultrasonic sensors 100 to obtain desired important signals is generally 1.2 ms, 0.08 ms may not be a value that significantly affects an operation of the ultrasonic sensor 100.

Operations of the multi-sensing apparatus configured as above will be described below.

First, the analyzed integrated circuit 200 may sequentially drive the plurality of ultrasonic sensors 100 along a fixed order, so that the driven wave transmission unit 110 of the ultrasonic sensor 100 transmits the ultrasonic wave signal of the corresponding transmission frequency.

As described above, when the wave transmission unit 110 of the plurality of ultrasonic sensors 100 transmits the ultrasonic wave signal of the corresponding transmission frequency, the corresponding ultrasonic wave signal may hit an object positioned on a propagation path for the signal to be reflected and returned, and the wave reception unit 130 of the corresponding ultrasonic sensor 100 may receive the ultrasonic reflected signal which is reflected and returned.

In this manner, when the wave reception unit 130 of the corresponding ultrasonic sensor 100 receives the ultrasonic wave signal, and outputs the received ultrasonic wave signal to the analyzed integrated circuit 200, the analyzed integrated circuit 200 may identify the ultrasonic sensor 100 in which the ultrasonic wave signal is input, determine a transmission time and a reception time of the recognized ultrasonic wave signal of the ultrasonic sensor 100, and then compute a distance using a time difference therebetween to thereby output the computed distance.

As described above, when sensing an object using the plurality of ultrasonic sensors 100, the multi-sensing apparatus according to the embodiment of the present invention may sense the object using a single analyzed integrated circuit 200, thereby reducing costs.

In addition, when sensing an object using the plurality of ultrasonic sensors 100, the multi-sensing apparatus according to the embodiment of the present invention may sense the object using the single analyzed integrated circuit 200, thereby realizing miniaturization of a product.

FIG. 2 is a block diagram illustrating the wave transmission unit of the ultrasonic sensor of FIG. 1.

Referring to FIG. 2, the wave transmission unit of the ultrasonic sensor of FIG. 1 includes a cylindrical case 112, for example, having a bottom. The case 112 may include a bottom surface 112a shaped into a disk, and a cylindrical side wall 112b. The case 112 may be made of a metal material such as aluminum, and the like. A cavity 114 formed inside the case 112 may be formed into, for example, a circular shape in its cross-section.

Meanwhile, a spreading scheme of the ultrasonic wave irradiated in the ultrasonic sensor 100 may be determined in accordance with a shape of the cavity 114, so that the shape of the cavity 114 may be changed to other shapes having, for example, a roughly elliptical cross-section in accordance with desired characteristics.

A piezoelectric element 116 may be attached to an inner surface of the bottom surface 112a inside the case 112. The piezoelectric element 116 may be obtained by forming electrodes in both of the surfaces of a piezoelectric body substrate shaped into a disk. The electrode on one surface side of the piezoelectric element 116 may be adhered on the bottom surface 112a by a conductive adhesive, or the like.

An attenuation material 118 made of, for example, silicon rubber may be attached to an end surface of an opening of the case 112. The attenuation material 118 may be used for preventing propagation of unnecessary vibrations from the case 112 or the piezoelectric element 116 to the outside, or intrusion of unnecessary vibrations from the outside to the case 112 or the piezoelectric element 116.

The attenuation material 118 may be formed into a disk shape having an outer diameter that is slightly smaller than an outer diameter of the case 112, however, slightly larger than an inner diameter of the case 112. In addition, an outer circumferential part of one surface side of the attenuation material 118 faces the end surface of the opening of the case 112, and at the same time, the center of the attenuation material 118 and the center of the case 112 may be arranged on the same line.

That is, the attenuation material 118 may be formed to cover the opening of the case 112. Two terminal holes 118a and 118b which pass through the cavity 114 of the case 112 while vertically passing through the both surfaces of the attenuation material 118 may be formed on the attenuation material 118 so as to be spaced apart from each other.

The substrate 120 formed into the disk shape using, for example, a glass-epoxy substrate may be attached to the other surface of the attenuation material 118. The substrate 120 may have the same outer diameter as that of the attenuation material 118, and the center of the substrate 120, and the center of the case 112, and the center of the attenuation material 118 may be arranged on the same line while one side surface of the substrate 120 facing the other side surface of the attenuation material 118.

Therefore, the attenuation material 118 may be formed between the end surface of the opening of the case 112 and the one side surface of the substrate 120. In addition, two terminal holes 120a and 120b may be formed on the substrate 120 so as to vertically pass through the both surfaces of the substrate 120. The terminal holes 120a and 120b may be formed to respectively correspond to the terminal holes 118a and 118b formed on the attenuation material 118.

In the substrate 120, two linear-shaped pin terminals 122a and 122b may be respectively pressed and inserted in the terminal holes 120a and 120b to be fixed.

In this case, one side end portion of each of the pin terminals 122a and 122b may be disposed in the one side surface of the substrate 120, that is, the inner surface, and the other side end portion thereof may be disposed on the other side surface of the substrate 120, that is, the outer surface. In addition, the one side end portion of each of the pin terminals 122a and 122b may be inserted to the terminal holes 118a and 118b formed in the attenuation material 118, and a tip portion of each of the pin terminals 122a and 122b may be disposed in the cavity 114 of the case 112.

In the inner surface of the side wall 112b of the case 112, an end of one side lead line 124a which is made of, for example, a polyurethane copper line as a connection member may be soldered. Thus, the lead line 124a may be electrically connected to the electrode in one surface side of the piezoelectric element 116 by interposing the case 112 therebetween. In addition, the other end of the lead line 124a may be soldered to a tip portion of one side end of the pin terminal 122a. Accordingly, the electrode in the one surface side of the piezoelectric element 116 may be electrically connected to the one side pin terminal 122a by interposing the case 112 and the lead line 124a therebetween.

In addition, an end of the other side lead line 124a which is made of, for example, a polyurethane copper line as the connection member may be soldered to the electrode on the other surface side of the piezoelectric element 116. The other end of the lead line 124b may be soldered to a top portion of the other side end of the other side pin terminal 122b. Accordingly, the electrode on the other side surface of the piezoelectric element 116 may be electrically connected to the other side pin terminal 122b by interposing the lead line 124b therebetween.

The ultrasonic sensor 100 having the above described configuration may apply a driving voltage to the pin terminals 122a and 122b, so that piezoelectric element 116 may be excited. The bottom surface 112a of the case 112 may vibrate by vibration of the piezoelectric element 116, so that ultrasonic waves may be radiated in a direction orthogonal to the bottom surface 112a. When ultrasonic waves radiated from the ultrasonic sensor 100 are reflected on an object to be detected to reach the ultrasonic sensor 100, the piezoelectric element 116 may vibrate to be converted into electrical signals, and the electrical signals may be output from the pin terminals 122a and 122b. Accordingly, by measuring a time required until the electrical signals are output after the driving voltage is applied, a distance from the ultrasonic sensor 100 to the object to be detected may be measured.

The resonance frequency (fsn) in the ultrasonic sensor 100 may be determined as below (Equation 1) in accordance with a thickness (t) of the disk-shaped bottom surface 112a of the case 112, a diameter (D) of the disk-shaped bottom surface 112a, and a material constant (kn) of the piezoelectric element 116, and a transmitting transmission frequency may be changed when one of to these factors is changed.

fsn=kn(t/D). [Equation 1]

Accordingly, in the case of the multi-sensing apparatus according to the embodiment of the present invention using the plurality of ultrasonic sensors 100, the ultrasonic wave signals of the mutually different transmission frequencies may be generated and transmitted when changing any one of the components of the ultrasonic sensor 100.

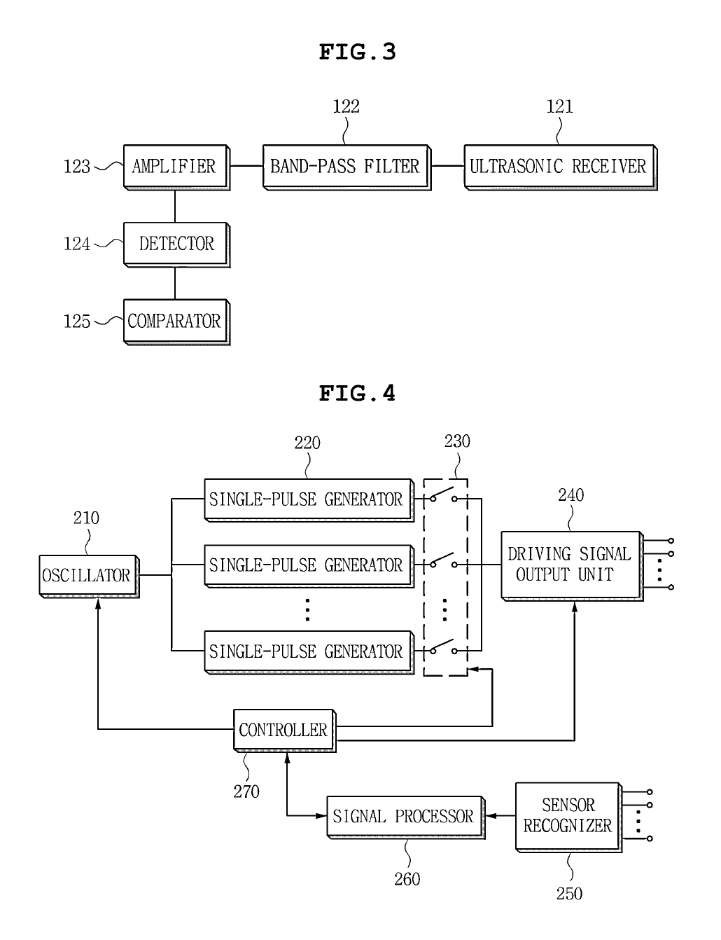

FIG. 3 is an inner block diagram illustrating a wave reception unit of FIG. 1.

Referring to FIG. 3, the wave reception unit of FIG. 1 may include an ultrasonic receiver 121 receiving an ultrasonic wave which hits on a predetermined object to be reflected, a band-pass filter 122 enabling only a resonance frequency having a maximum voltage among frequencies received from the ultrasonic receiver 121 to pass therethrough, an amplifier 123 adjusting an amplification ratio of the ultrasonic wave signal passing through the band-pass filter 122 in accordance with a scale of a predetermined noise, a detector 124 detecting a signal passing through the amplifier 123, and a comparator 125 comparing the signal detected in the detector 124 with a linear reference signal to convert the compared value into a digital value.

Here, the detector 124 and the comparator 125 may be used for converting outputting signals into digital signals by the wave reception unit, and thus will be omitted, as necessary.

As for the wave reception unit configured as above, the ultrasonic receiver 121 may receive the ultrasonic wave that hits on the predetermined object and is reflected, and the band-pass filter 122 may enable only the resonance frequency having the maximum voltage among frequencies received from the ultrasonic receiver 121 to pass through the band-pass filter 122.

In addition, an amplification ratio of the ultrasonic wave signal passing through the band-pass filter 122 may be adjusted in accordance with a scale of a predetermined noise, and the amplification ratio adjusted by the amplifier 123 may detect the ultrasonic wave signal by the detector 124.

In addition, the signal detected in the detector 124 may be compared with the linear reference signal, and the compared value may be converted into a digital value in the comparator 125 to be output.

FIG. 4 is an inner block diagram illustrating an analyzed integrated circuit of FIG. 1.

Referring to FIG. 4, the analyzed integrated circuit of FIG. 1 may include an oscillator 210, a plurality of single-pulse generators 220, a pulse selector 230, a driving signal output unit 240, a sensor recognizer 250, a signal processor 260, and a controller 270.

The oscillator 210 may receive power supplied from a power supply device (not shown), and generate a clock pulse.

The plurality of single-pulse generators 220 may generate a corresponding single driving pulse using the clock pulse output from the oscillator 210 generating the clock pulse.

Next, the pulse selector 230 may select any one of the output signals of the plurality of single-pulse generators 220 in accordance with a control of the controller 270, and output the selected signal to the driving signal output unit 240.

The driving signal output unit 240 may output the corresponding pulse selected in the pulse selector 230 to the wave transmission unit of the corresponding ultrasonic sensor.

Meanwhile, when the ultrasonic wave signals are input from the wave reception units of the plurality of ultrasonic sensors 100, the sensor recognizer 250 may recognize the ultrasonic sensor 100 to which the ultrasonic wave signal is input, and output an identification signal (as an example, an identification number) and a reception time which identify the corresponding ultrasonic sensor 100 and a reception time.

Next, the signal processor 260 may determine a distance of the object sensed by the corresponding ultrasonic sensor, using the identification signal (as an example, the identification number) and the reception time, which identify the corresponding ultrasonic sensor 100, output from the sensor recognizer 250.

Operations of the analyzed integrated circuit as above will be described as below.

First, the controller 270 may drive the oscillator 210, and generate the clock signal using the power input from the power supply device.

Next, the clock signal generated by the oscillator 210 may be input to the plurality of single-pulse generators 220, and the plurality of single-pulse generators 220 may generate and output a pulse signal having the corresponding resonance frequency.

Thereafter, the controller 270 may control the pulse selector 230, so that the pulse signal output from the plurality of single-pulse generators 220 may be sequentially selected.

In this instance, the order selected by the pulse selector 230 may proceed in accordance with an order determined in advance, or randomly selected in an arbitrary order.

In this manner, the pulse signal selected by the pulse selector 230 may be output to the driving signal output unit 240, and the driving signal output unit 240 may output the pulse signal of the corresponding resonance frequency to the corresponding ultrasonic sensor by a control of the controller.

Meanwhile, when the ultrasonic wave signals are input from the wave reception units of the plurality of ultrasonic sensors 100, the sensor recognizer 250 may recognize the ultrasonic sensor 100 to which the ultrasonic wave signal is input to thereby determine the corresponding ultrasonic sensor 100.

In this instance, when the signals input from the plurality of ultrasonic sensors 100 are analog signal, the sensor recognizer 250 may detect the resonance frequency, and identify the corresponding ultrasonic sensor 100 using the detected resonance frequency.

Unlike this, when the plurality of ultrasonic sensors 100 output digital signals, the sensor recognizer 250 may identify an input line of the digital signal to thereby determine the ultrasonic sensor 100.

Next, the signal processor 260 may determine a distance of the object sensed by the corresponding ultrasonic sensor, using the identification signal (as an example, the identification number), the transmission time, and the reception time, which identify the corresponding ultrasonic sensor 100, output from the sensor recognizer 250.

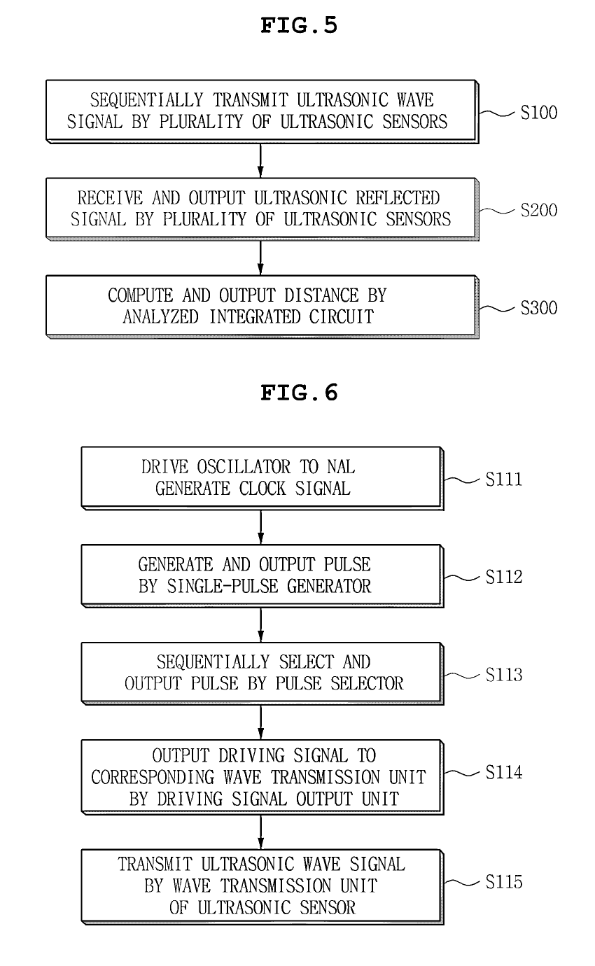

FIG. 5 is a flowchart illustrating a multi-sensing method according to an embodiment of the present invention.

Referring to FIG. 5, as for a multi-sensing method according to an embodiment of the present invention, in S100, the analyzed integrated circuit 200 may sequentially drive the plurality of ultrasonic sensors 100 in a fixed order, and the wave transmission unit of each of the plurality of ultrasonic sensors 100 may sequentially output an ultrasonic wave signal of the corresponding transmission frequency.

Next, in S200, the wave reception unit 130 of each of the plurality of ultrasonic sensors 100 may receive and output an ultrasonic reflected signal in which the transmitted ultrasonic wave signal hits on an object positioned in a propagation path for the signal, and is reflected and returned.

Next, in S300, the analyzed integrated circuit 200 may receive the ultrasonic wave signal received from the wave reception unit 130 of each of the plurality of ultrasonic sensors 100, identify and recognize the ultrasonic sensor to which the ultrasonic wave signal is input, determine the transmission time and the reception time of the ultrasonic wave signal of the recognized ultrasonic sensor 100, and compute a distance using a time difference, and output the computed distance.

As described above, according to the embodiment of the present invention, when sensing the object using the plurality of ultrasonic sensors, a single analyzed integrated circuit may be used, thereby reducing costs.

In addition, when sensing the object using the plurality of ultrasonic sensors, a single analyzed integrated circuit may be used, thereby realizing miniaturization of a product.

FIG. 6 is a detailed configuration diagram illustrating outputting of an ultrasonic wave signal of FIG. 5.

Referring to FIG. 6, as for the outputting of the ultrasonic wave signal of FIG. 5, the controller may drive the oscillator to generate a clock signal in S111, and the plurality of single-pulse generators may receive the clock signal to generate and output a pulse signal having the corresponding resonance frequency in S112.

Next, in S113, the pulse selector may select the pulse signal output from the plurality of single-pulse generators, in accordance with a control of the controller in an order determined in advance, or randomly select in an arbitrary order to thereby output the selected signal.

In S114, the pulse signal selected by the pulse selector may be output to the driving signal output unit, and the driving signal output unit may output the pulse signal of the corresponding resonance frequency to the corresponding ultrasonic sensor using the controller. In S115, the wave transmission unit of the corresponding ultrasonic sensor may generate and transmit the corresponding ultrasonic wave signal.

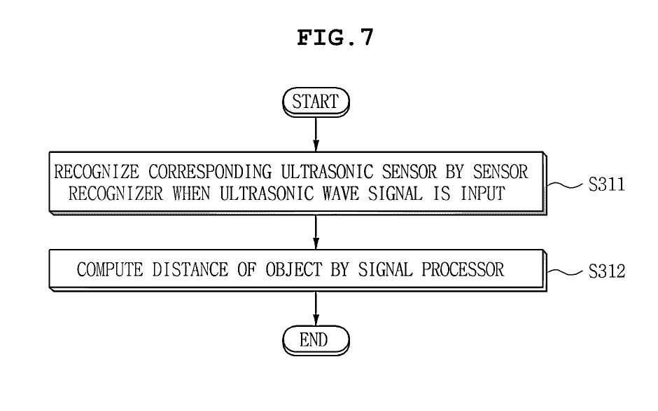

FIG. 7 is a flowchart illustrating computing of a distance of FIG. 5.

Referring to FIG. 7, as for the computing of the distance of FIG. 5, in S311, when the ultrasonic wave signal is input from the wave reception unit of each of the plurality of ultrasonic sensors, the sensor recognizer may recognize the ultrasonic sensor to which the ultrasonic wave signal is input, and determine the corresponding ultrasonic sensor.

In this instance, when the signal input from the plurality of ultrasonic sensors is an analog signal, the sensor recognizer may detect the resonance frequency, and identify the corresponding ultrasonic sensor using the detected resonance frequency.

Unlike this, when the plurality of ultrasonic sensors output digital signals, the sensor recognizer may identify an input line of the digital signal, and determine the ultrasonic sensor.

Next, in S312, the signal processor may determine a distance of the object sensed by the corresponding ultrasonic sensor using the identification signal (as an example, an identification number), the transmission time, and the reception time, which identify the corresponding ultrasonic sensor, output from the sensor recognizer.

As described above, according to the embodiments of the present invention, when sensing an object using the plurality of ultrasonic sensors, a single analyzed integrated circuit may be used, thereby reducing costs.

Also, according to the embodiments of the present invention, when sensing an object using the plurality of ultrasonic sensors, a single analyzed integrated circuit may be used, thereby realizing miniaturization of a product.

Although the preferred embodiments of the present invention have been disclosed for illustrative purposes, they are for specifically explaining the present invention. Therefore, a multi-sensing apparatus and a method thereof according to the preferred embodiments of the present invention is not limited thereto, but those skilled in the art will appreciate that various modifications and alterations are possible, without departing from the scope and spirit of the invention as disclosed in the accompanying claims. Accordingly, such modifications and alterations should also be understood to fall within the scope of the present invention. A specific protective scope of the present invention could be defined by the accompanying claims.

What is claimed is:

1. A multi-sensing apparatus, comprising:
a plurality of ultrasonic sensors including a wave transmission unit transmitting an ultrasonic wave signal of a corresponding transmission frequency, and a wave reception unit receiving and outputting the ultrasonic wave signal transmitted from the wave transmission unit; and
an analyzed integrated circuit controlling each of the wave transmission units of the plurality of ultrasonic sensors to transmit the ultrasonic wave signal of the corresponding transmission frequency, receiving an ultrasonic reflected signal received from each of the reception wave units, and computing and outputting a distance of an object sensed by a corresponding ultrasonic sensor using a time difference between a transmission time and a reception time.

2. The multi-sensing apparatus as set forth in claim 1, wherein:
each of the wave transmission units of the plurality of ultrasonic sensors includes:
a cylindrical case having a bottom;
a piezoelectric element formed in an inner bottom surface of the case;
a terminal electrically connected to the piezoelectric element; and
a substrate in which the terminal is fixed, and
each of the wave transmission units of the plurality of ultrasonic sensors has mutually different transmission frequencies by adjusting a thickness or a diameter of the bottom surface of the case of the corresponding wave transmission unit, or a material constant of the piezoelectric element to be different from each other.

3. The multi-sensing apparatus as set forth in claim 1, wherein each of the wave reception units of the plurality of ultrasonic sensors includes:
an ultrasonic receiver receiving an ultrasonic wave which hits on a predetermined object to be reflected,
a band-pass filter enabling only a resonance frequency having a maximum voltage among frequencies received from the ultrasonic receiver to pass therethrough, and
an amplifier adjusting an amplification ratio of the ultrasonic wave signal passing through the band-pass filter in accordance with a scale of a predetermined noise.

4. The multi-sensing apparatus as set forth in claim 3, wherein each of the wave reception units of the plurality of ultrasonic sensors further includes:
a detector detecting a signal passing through the amplification; and
a comparator comparing the signal detected in the detector with a linear reference signal to convert the compared value into a digital value.

5. The multi-sensing apparatus as set forth in claim 1, wherein the analyzed integrated circuit includes:
an oscillator generating a clock signal;
a plurality of single-pulse generators generating a single driving pulse of a corresponding resonance frequency by receiving the clock signal;
a pulse selector selecting and outputting any one of the single driving pulses output from the plurality of single-pulse generators; and
a driving signal output unit applying the single driving pulse output from the pulse selector to the corresponding ultrasonic sensor.

6. The multi-sensing apparatus as set forth in claim 1, wherein the analyzed integrated circuit includes:
a sensor recognizer receiving the ultrasonic wave signal input from the wave reception unit to recognize the corresponding ultrasonic sensor;
a signal processor computing a distance of an object sensed using the transmission time and the reception time of the ultrasonic wave signal of the ultrasonic sensor recognized in the sensor recognizer; and
a controller controlling a pulse selector and a driving signal output unit.

7. A multi-sensing method, comprising:
sequentially outputting an ultrasonic wave signal of a corresponding transmission frequency by driving a plurality of ultrasonic sensors by an analyzed integrated circuit;
receiving and outputting, by the plurality of ultrasonic sensors, an ultrasonic reflected signal in which the transmitted ultrasonic wave signal is reflected and returned; and
receiving, by the analyzed integrated circuit, the ultrasonic wave signal received from the plurality of ultrasonic sensors, and identifying the ultrasonic sensor in which the ultrasonic wave signal is input, and computing and outputting a distance using a transmission time and a reception time of the ultrasonic wave signal of the corresponding ultrasonic sensor.

8. The multi-sensing method as set forth in claim 7, wherein the sequentially outputting includes:
generating a clock signal by driving an oscillator by a controller of the analyzed integrated circuit;
generating and outputting a pulse signal having a corresponding resonance frequency by receiving the clock signal by a plurality of single-pulse generators of the analyzed integrated circuit;
sequentially selecting and outputting, by a pulse selector of the analyzed integrated circuit, a pulse signal output from the plurality of single-pulse generators in accordance with a control of the controller;
outputting, by a driving signal output unit of the analyzed integrated circuit, the pulse signal of the corresponding resonance frequency to the corresponding ultrasonic sensor in accordance with the control of the controller; and
generating and transmitting the corresponding ultrasonic wave signal by a wave transmission unit of the corresponding ultrasonic sensor.

9. The multi-sensing method as set forth in claim 7, wherein the receiving of the ultrasonic wave signal includes:
recognizing, by a sensor recognizer of the analyzed integrated circuit, the ultrasonic sensor in which the ultrasonic wave signal is input when the ultrasonic wave signal is input from the plurality of ultrasonic sensors, and determining the corresponding ultrasonic sensor; and
computing and outputting, by a signal processor of the analyzed integrated circuit, the distance of an object sensed by the corresponding ultrasonic sensor using the transmission time and the reception time of the ultrasonic wave signal of the ultrasonic sensor recognized in the sensor recognizer.
